(19) United States
(12) Patent Application Publication
(10) Pub. No.: US 2010/0005017 A1
(43) Pub. Date: Jan. 7, 2010

(54) BILLING METHOD AND SYSTEM, AND BILL CYCLE CUT OFF MODULE

(76) Inventors: Bin WANG, Shenzhen (CN); Zhixian Xu, Shenzhen (CN); Xiaoli Zhang, Shenzhen (CN); Qiuhua Xie, Shenzhen (CN); Tingrong Chen, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/557,781

(22) Filed: Sep. 11, 2009

Related U.S. Application Data
(63) Continuation of application No. PCT/CN2008/070500, filed on Mar. 14, 2008.

(30) Foreign Application Priority Data
Mar. 15, 2007 (CN) 200710088219.1

(51) Int. Cl. G06Q 30/00; G06F 15/16

(52) U.S. Cl. 705/34; 709/204

(57) ABSTRACT

A billing method, and a billing system and a bill cycle cut off module which may be used in implementing the method, are provided. The method includes receiving an online billing message and carrying out preprocessing for the message, wherein the online billing message includes user identification information and billing information. The message further includes executing an online bill cycle cut off operation after determining that the bill cycle cut off operation is required to be triggered for an account related to the user identification information, obtaining a result of the bill cycle cut off, and carrying out a rating and billing operation according to the billing information so as to complete billing. The provided method can be applied to implement a real-time online bill cycle cut off and avoid loss resulted from out-of-time bill cycle cut off. Moreover, the provided method may incorporate online billing and offline billing, can be implemented flexibly, and can easily realize individualized bill cycle setting. During the account cancellation process for the user, the provided method may can shorten the waiting time of the user and improve customer satisfaction.

### CROSS-REFERENCE TO RELATED APPLICATIONS

This application is a continuation of International Patent Application No. PCT/CN/2008070500, filed Mar. 14, 2008, which claims the priority of Chinese Patent Application No. 200710088219.1, filed Mar. 15, 2007, the contents of both of which are incorporated herein by reference in their entirety.

### TECHNICAL FIELD

This disclosure relates to the technical field of billing, and in particular to a billing method and system, and a bill cycle cut off module.

### BACKGROUND

A billing system is an important part in the telecommunication operation field, and it works to form the entire telecommunication operation together with service provision and service ensurance.

In a traditional offline billing system, a network element, such as a switch, a Mobile Switch Center (MSC), a Gateway GPRS Support Node (GGSN) and the like, logs information of network resource usage or service usage, creates Call Detail Recording (CDR) that is temporarily stored in the network element in the form of a CDR file. The billing system collects (for example, in FTP protocol) the CDR file from the network element periodically, extracts relevant information of service usage and network resource usage from the CDR file, and takes the information as a basis for billing to support the subsequent billing procedures. Hereinafter, the implementation procedures of traditional offline billing are described in detail.

The network element creates a CDR file from the information on service used by a terminal. Specifically, the billing information is usually logged by item in the CDR file; a collecting system in the billing system extracts the CDR file from the network element, carries out preprocessing operations, such as duplicate checking, error correcting, bill combining, formatting and the like, for the billing information in the CDR file, and then sends the preprocessed information to a rating and billing module for rating.

After receiving the pre-processed CDR billing information, for each item of billing information in the CDR file, the rating and billing module extracts service information in the billing information, and searches for the preset price information of the service according to the service information. For example, the price for local call service may be: 0.1RMB per minute for first 3 minutes, and 0.05RMB per minute after the first 3 minutes, etc. The rating and billing module calculates service usage fee for a user according to the obtained price information and a service usage amount in the rating information. For example, start and termination time of a call is from 8:56:11 to 9:00:28 in a day, or the call duration is 5 minutes. Then, the subsequent billing module charges the service usage fee to an account related to the terminal according to a payment relationship of the user.

In order to facilitate account management, a concept of “bill cycle” is introduced, i.e., for an account, continuous time is split artificially into time periods, and each time period is referred to as a bill cycle. In account management, charge data of an account is accumulated and collected by different bill cycles, so as to support charging the user by bill cycle subsequently. At present, a calendar month is usually taken as a bill cycle. For example, an operator usually takes 0:00 a.m. of the first day of each calendar month as bill cycle cut off time, and therefore, the duration before the 0:00 a.m. of the first day of each month and after the 0:00 a.m. of the first day of the previous month is taken as a bill cycle. In a bill cycle, the billing information is accumulated and collected. After a bill cycle cut off, a new bill cycle starts, and the charge data of the previous bill cycle is calculated to be a basis for providing a bill to the user; and the user pays the bill after confirming the bill.

A series of operations for accumulating account data of the previous bill cycle according to the bill cycle cut off point and initializing a new bill cycle are referred to as a bill cycle cut off. During the bill cycle cut off process, the charge data of the previous bill cycle before the bill cycle cut off point must be accumulated and collected, and the final charge data must be stored in a different location for the use of subsequent functions, such as making a bill.

For the reason that a traditional billing system carries out billing through a CDR call ticket in an offline way, it may cause a call ticket delay in some abnormal cases, i.e., a call ticket file or a call ticket record pertaining to the previous bill cycle is collected to the billing system for rating only after a bill cycle cut off. The charge data after rating should be the charge data generated in the previous bill cycle. Therefore, if the charge data is to be billed into the previous bill cycle, it has an adverse effect on the billing process. In a specific system implementation process, according to the service requirement of the operator, for the above call ticket delay condition, the billing function in some systems may determine whether to bill the charge data into the previous bill cycle or the current bill cycle according to the generation time of the charge, i.e., the billing function supports both billing into the previous bill cycle and billing into the current bill cycle. However, in other systems, the billing function bills all charge data after a bill cycle cut off into the current bill cycle.

The implementation mechanism of the bill cycle cut off in the existing system is to run a bill cycle cut off detector in the background. When having detected that the time for the bill cycle cut off is reached, the bill cycle cut off detector triggers a bill cycle cut off process to execute the bill cycle cut off operation in batch for all users. In an actual operation, in order to avoid adverse effects on a production system, the bill cycle cut off operation is usually performed only when the network is in an idle state (for example, at midnight). In addition, during the bill cycle cut off process, in order to prevent collision resulting from concurrent billing data manipulation by the rating and billing module and the bill cycle cut off module, the billing function typically has to be deactivated during the bill cycle cut off process, and such time period is referred to as an “account locking period”. During the process in which the billing function is deactivated, the account data may not be updated in time, and it is unable to carry out credit control for the users. Therefore, such process may cause loss to the operator.

As we all know, offline billing is not real-time, and it is typically applied to charge post-paid users. Although offline billing may support diverse services, it is unable to provide credit control for the users, and therefore may lead to a risk of loss due to malicious overdrawing.

Intelligent Network based billing is implemented in a real-time billing mechanism: when a user requests a service, a Service Switching Point (SSP) reports the service information requested by the user and the user information to a Service Control Point (SCP). According to the reported information and the user's account information, the SCP determines whether the balance in the user's account is enough, so as to decide whether the user may keep enjoying the service and control the SSP to decide whether to switch the service for the user. During the process in which the user uses the service, the SCP collects the service usage information reported from the SSP continuously, deducts usage fee from the user's account in real time, and controls the SSP to terminate the service for the user when the balance in the user's account is not enough. Real-time billing may effectively control malicious overdrawing and avoid arrears, and is applied to charge prepaid users presently. However, the Intelligent Network based online billing method employs simple prices. In addition, because it employs real-time charge deduction instead of billing by bill cycle, it is usually unable to provide a bill for a user, but only to provide a detailed list of service usage, and therefore may not meet the requirement of users.

However, online billing and offline billing are usually used for prepaid users and post-paid users respectively, and the online billing system and the offline billing system are separate from each other and therefore cause dispersed user data and increased operation cost. In addition, due to different provided services caused by different billing patterns, it is difficult to implement cross preferential treatment among different services. It is urgent for the billing system to incorporate the prepaid and the post-paid.

It can be seen that the existing billing method does not support a real-time online bill cycle cut off, and the bill cycle cut off requires a long time and has poor flexibility. In addition, because the existing bill cycle cut off is processed in batch in offline mode and usually is performed when the network is in an idle state (for example, at midnight), it is difficult to support individualized bill cycle customization for different users. Before the bill cycle cut off is completed, it is difficult to accurately collect and accumulate the charge in the bill cycle. When a user makes account cancellation, it is difficult to perform accurate statistic tasks on the charge in the current bill cycle, and therefore loss may occur for the operator. During the account cancellation process, the user has to wait for a long time till the current bill cycle terminates, and therefore customer satisfaction is degraded.

### SUMMARY OF THE DISCLOSURE

A billing method and system, and a bill cycle cut off module are provided in embodiments of this disclosure, so as to implement real-time online bill cycle cut off and avoid loss resulted from out-of-time bill cycle cut off.

According to an embodiment of this disclosure, a billing method is provided. The billing method includes:

receiving an online billing message and carrying out preprocessing for the message, wherein the online billing message includes user identification information and billing information; and

executing an online bill cycle cut off operation after determining that the bill cycle cut off operation is required to be triggered for an account related to the user identification information, obtaining a result of the bill cycle cut off, and carrying out a rating and billing operation according to the billing information so as to complete billing.

A billing system according to another embodiment is also provided. The billing system includes:

a billing information collecting and preprocessing module, configured to receive an online billing message and carry out preprocessing for the message, wherein the online billing message includes user identification information and billing information;

a main control module, configured to transmit a preprocessed online billing message, receive feedback information, and invoke a rating and billing module to carry out billing upon determining that the feedback information includes a result of a bill cycle cut off, receive a result of a rating and billing operation, and return a response for the billing message to an initiator of the online billing message via the billing information collecting and preprocessing module;

a bill cycle cut off module, configured to execute an online bill cycle cut off operation after determining that the bill cycle cut off operation is required to be triggered for an account related to the user identification information, and return the result of the bill cycle cut off to the main control module; and

a rating and billing module, Configured to carry out the rating and billing operation according to the billing information.

According to an embodiment of the present disclosure, there is also provided a bill cycle cut off module. The bill cycle cut off module includes:

a cut off determining unit, configured to receive from a main control module an online billing message including user identification information, and determine whether a bill cycle cut off operation is required to be triggered for an account related to the user identification information;

a bill cycle cut off unit, configured to execute an online bill cycle cut off operation according to a notification from the cut off determining unit and obtain a result of the bill cycle cut off; and

a result return unit, configured to transmit to the main control module the result of the bill cycle cut off received from the bill cycle cut off unit.

The embodiments of this disclosure can implement a real-time online bill cycle cut off and avoid loss resulted from out-of-time bill cycle cut off. The embodiments of this disclosure can incorporate online billing and offline billing, can be implemented flexibly, and can easily realize individualized bill cycle setting. During the account cancellation process of the user, this disclosure can shorten the waiting time of the user and improve customer satisfaction.

### BRIEF DESCRIPTION OF THE DRAWINGS

FIG. 1 is a schematic diagram of a flow for implementing the billing method according to an embodiment of this disclosure;

FIG. 2 is a schematic diagram of a processing flow of the bill cycle cut off module according to an embodiment of this disclosure;

FIG. 3 is a schematic diagram of a billing process for a complete call process according to an embodiment of this disclosure;

FIG. 4 is a schematic diagram of a flow of an operation for triggering a bill cycle cut off in a batch processing mode;

FIG. 5 is a structural diagram of the bill cycle cut off module according to an embodiment of this disclosure.

### DETAILED DESCRIPTION OF THE EMBODIMENTS

Hereinafter, this disclosure is further described in detail, with reference to the accompanying drawings and the embodiments.

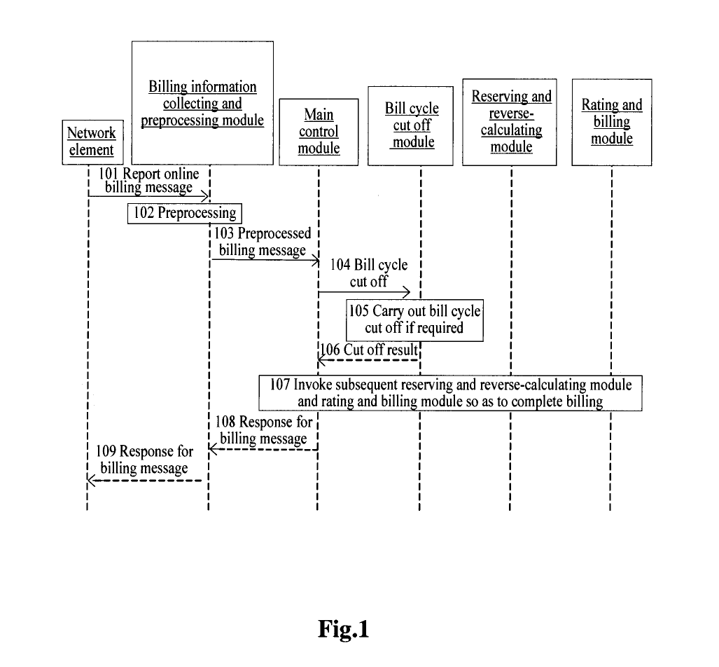

FIG. 1 is a schematic diagram of a flow for implementing the billing method according to the embodiment of this disclosure. The billing method includes the following steps.

Step 101, a network element reports to the billing system an online billing message including user identification information and billing information. Specifically, the network element may be an SCP, a GGSN, an MSC, etc.

Steps 102 to 103, a billing information collecting and preprocessing module in the billing system receives the online billing message, carries out preprocessing for the message, and then sends the preprocessed online billing message to a main control module in the billing system.

Specifically, the billing information collecting and preprocessing module is mainly responsible for collecting billing information from the network element in a specific protocol and carrying out preprocessing for the billing information, and then the preprocessed billing information is converted into a uniform format for the use of subsequent billing procedures. The collected billing information includes, but is not limited to: a billing message, a CDR or an IP Detail Record (IPDR) file. The preprocessing includes operations such as coding/decoding, formatting and duplicate checking for the billing information and the like. The module and the processing procedures thereof are described in the existing solution, and the description thereof is omitted here.

Steps 104 to 106, the main control module invokes a bill cycle cut off module via a bill cycle cut off interface, i.e., it sends a bill cycle cut off message including user identification information to the bill cycle cut off module. The bill cycle cut off module determines whether a bill cycle cut off operation is required to be triggered for an account related to the user identification information. If a bill cycle cut off operation is required to be triggered, the bill cycle cut off module executes the online bill cycle cut off operation, and transmits a result of the bill cycle cut off to the main control module; otherwise, it directly returns to the main control module information for indicating that no bill cycle cut off is required.

In the embodiment, it is assumed that the bill cycle cut off is required and the result of the bill cycle cut off is returned.

Step 107, the main control module obtains the result of the bill cycle cut off, and invokes a reserving and reverse-calculating module and/or a rating and billing module to carry out a reserving and reverse-calculating operation and/or a rating and billing operation according to the billing information so as to complete billing.

The rating and billing module is adapted to calculate fees to be paid due to service usage by the user according to the price information and the service usage amount extracted from the billing information, and update the account information for the user, such as the balance in the account, detailed service records related to the fee and the like.

The reserving and reverse-calculating module is adapted to carry out reverse-calculating according to the account information and service information of the user, and carry out a reserving operation for the user using the service. Reverse calculating refers to calculate the amount of the service available to the user according to the current balance in the account and the price information of using the service, such as available call duration remained, available bytes of traffic information for downloading. In addition, the reserving and reverse-calculating module may notify the user of the result of the reverse-calculated service amount, or use the result in the subsequent billing procedures (for example, reserving). Reserving is a credit control mechanism for online billing, and is used to avoid unnecessary loss of the operator, i.e., for a service used by a user, a certain amount of money is pre-deducted in advance from the balance of the user's account. After the user has used the service, the remaining pre-deducted amount of money is reimbursed.

The further description for the step is omitted, for the reason that reference may be made to the implementation in the prior art.

Steps 108 to 109, the main control module returns a response for the billing message to the network element via the billing information collecting and preprocessing module.

Thus, a billing method incorporating online billing and offline billing is implemented.

The aforementioned online billing message may be a session-based message or an event-based message. For the session-based message, a billing initiation message, a billing update message, and a billing termination message may be included in a session. Of course, the billing update message may not be included. For example, after the user starts the call and the network element reports the billing initiation message, the billing system may reserve 5 minutes. If the user terminates the call within 5 minutes, the network element reports a billing termination message directly, and thus there is no billing update message. If the call lasts for 23 minutes, a plurality of billing update messages are produced. It can be understood that for a call process, a billing initiation message, a billing termination message, and none or at least one billing update message may be included. For the event-based message, only an event message occurs for an event; no reverse-calculating or reserving is required; fee is deducted directly after rating and billing is carried out; and thus the reserving and reverse-calculating operation is not required.

The protocol used to bear the online billing message may be the Diameter and the Radius and the like, i.e. the network element may communicate with the billing system in a protocol such as the Diameter or the Radius and the like. In addition, the network element may report the CDR or IPDR file to the billing system through a specific file or stream transfer protocol. The specific file or stream transfer protocol includes, but is not limited to: the File Transfer Protocol (FTP), the File Transfer Access and Management (FTAM) protocol, the IP Detail Record/Stream Processor (IPDR/SP) protocol, etc.

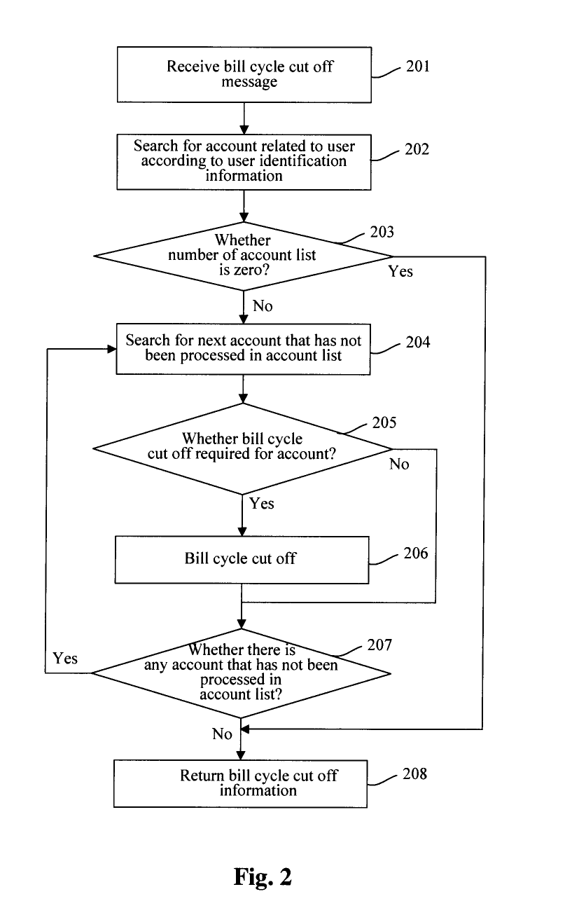

The processing procedures for determining whether a bill cycle cut off operation is required to be triggered for the account related to the user identification information and performing a bill cycle cut off as described in Steps 104 to 106 in FIG. 1 are shown in FIG. 2. FIG. 2 is a schematic diagram of a processing flow of the bill cycle cut off module according to the embodiment of this disclosure.

Steps 201 to 202, after the bill cycle cut off module receives the bill cycle cut off message, it extracts the user identification information from the message, searches for an account (which is also referred to as a payment relationship in the prior art) related to the user identification information, and obtains an account list related to the user identification information.

Step 203, the module determines whether the number of the list is zero. If the number of the list is zero, it executes Step 208; otherwise it executes Step 204.

Step 204, the module searches for the next account that has not been processed in the account list.

Step 205, the module determines whether a bill cycle cut off is required for the account according to a preset rule. If a bill cycle cut off is required, it executes Step 206; otherwise it executes Step 207.

The aforementioned preset rule may be: the current occurrence time of the billing message is later than the termination time of the current bill cycle for the current account.

Step 206, the module executes the online bill cycle cut off in either of the following two ways:

In the first way, if a storing space exists and the charge data of the current bill cycle and the charge data of the previous bill cycle are stored at different storage positions, the process for executing the online bill cycle cut off process includes: storing the charge data of the current bill cycle to a storage position where the charge data of the previous bill cycle is stored, clearing the charge data of the current bill cycle except the balance of the current bill cycle, inheriting the balance data in the storage position as the balance data of a current bill cycle, and then changing start and termination time of the current bill cycle to those time having passed through the bill cycle cut off for the account.

In the second way: if two storing spaces for storing the charge data of the current bill cycle and the charge data of the previous bill cycle respectively exist, and an identifier or a pointer of the current bill cycle and an identifier or a pointer of the previous bill cycle for identifying or pointing to the charge data of the two bill cycles respectively exist, a process for executing the online bill cycle cut off process includes: exchanging the identifier or the pointer of the current bill cycle with the identifier or the pointer of the previous bill cycle, clearing the charge data of a bill cycle identified by the exchanged identifier of the current bill cycle or pointed to by the exchanged pointer of the current bill cycle except the balance of the bill cycle, inheriting the balance data of the bill cycle as the balance data of a current bill cycle, and then changing start and termination time of the current bill cycle to those time having passed through the bill cycle cut off for the account.

Step 207, the module determines whether there is any account that has not been processed in the account list. If there is an account that has not been processed in the account list, it returns to Step 204; otherwise it executes Step 208.

Step 208, the module returns bill cycle cut off information.

Here, if the bill cycle cut off operation is executed, the result of the bill cycle cut off is returned; if no bill cycle cut off operation is executed, information for indicating that no bill cycle cut off is required is returned.

It is obvious that each account in the account list should be determined in sequence according to the preset rule, if the number of accounts in the account list is not zero.

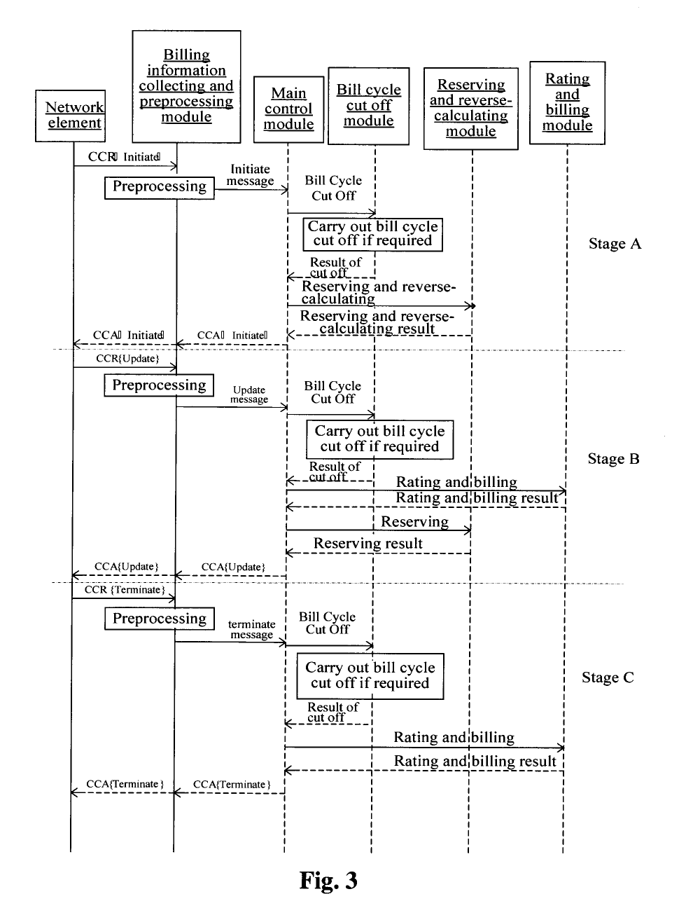

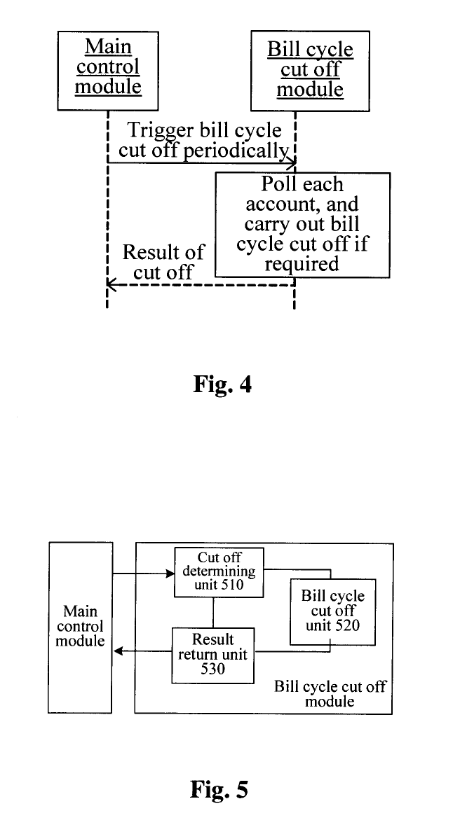

FIG. 3 is a schematic diagram of the billing process for a complete call process according to the embodiment of this disclosure. The embodiment is based on the Diameter protocol.

Here, a complete call process may be divided into three stages: the time before the user actually starts the call is referred to as a “before service” stage, the time in the call process is referred to as a “in service” stage, and the time when the user terminates the call or when the network element terminates the call due to insufficient balance is referred to as a “service terminated” stage. These stages are described as follows.

In the “before service” stage, i.e., in stage A as shown in FIG. 3, the network element reports a Diameter CCR Initiate message (an online billing initialization message) to the billing system. When receiving the Diameter CCR Initiate message, the billing system carries out preprocessing for the message, and then transmits the preprocessed message to the main control module in the billing system. The main control module sends a bill cycle cut off message including user identification information to the bill cycle cut off module.

The bill cycle cut off module detects whether a bill cycle cut off operation is required to be triggered for the account related to the user identification information according to the user identification information; if a bill cycle cut off is required, it carries out bill cycle cut off processing, and returns the result of the bill cycle cut off to the main control module after the bill cycle cut off is completed; if no bill cycle cut off is required, it returns to the main control module information for indicating that no bill cycle cut off is required. In the embodiment, it is assumed that information of the result of the bill cycle cut off is returned.

With reference to the result of the bill cycle cut off, the main control module controls and invokes the reserving and reverse-calculating module to carry out reserving and reverse calculating for the user using the service, and finally accomplishes the processing process of the Diameter CCR Initiate message.

In the “in service” stage, i.e., the stage B as shown in FIG. 3, the network element reports a Diameter CCR Update message (an online billing update message) periodically. After receiving the Diameter CCR Update message, the billing system carries out preprocessing for the message, and transmits the preprocessed billing message to the main control module in the billing system. The main control module sends a bill cycle cut off message including user identification information to the bill cycle cut off module.

The bill cycle cut off module detects whether a bill cycle cut off operation is required to be triggered for the account related to the user identification information according to the user identification information; if a bill cycle cut off is required, it carries out bill cycle cut off processing, and returns the result of the bill cycle to the main control module after the bill cycle cut off is completed; if no bill cycle cut off is required, it returns to the main control module information for indicating that no bill cycle cut off is required. In the embodiment, it is assumed that information of the result of the bill cycle cut off is returned.

After receiving the message from the bill cycle cut off module, the main control module controls the subsequent rating and billing module to carry out the rating and billing operation for the service amount used by the user with reference to the information of the result of the bill cycle cut off, and invokes the reserving and reverse-calculating module to carry out the reserving operation for the user using the service, and finally accomplishes the processing process of the Diameter CCR Update message.

In the embodiment, the online billing update message occurs only once. If required, the online billing update message may be produced a plurality of times, or no online billing update message is produced.

In “service terminated” stage, i.e., the stage C as shown in FIG. 3, the network element reports a Diameter CCR Terminate message (an online termination message) to the billing system. After receiving the Diameter CCR Terminate message, the billing system carries out preprocessing for the message, and then sends the preprocessed Diameter CCR Terminate message to the main control module. The main control module sends a bill cycle cut off message including user identification information to the bill cycle cut off module.

The bill cycle cut off module detects whether a bill cycle cut off operation is required to be triggered for the account related to the user identification information according to the user identification information; if a bill cycle cut off is required, it carries out the bill cycle cut off processing, and returns the result of the bill cycle cut off to the main control module after the bill cycle cut off is completed; if no bill cycle cut off is required, it returns to the main control module information for indicating that no bill cycle cut off is required. In the embodiment, it is assumed that information of the result of the bill cycle cut off is returned.

It is noted that the reason for determining whether a bill cycle cut off is required to be triggered is: for example, if the termination time of the bill cycle of the user is Mar. 1, 2007 and the user starts a call at 23:57 on February 28 and terminates the call at 00:02 on March 1, a bill cycle cut off is required because a part of the call time goes beyond the termination time of the bill cycle.

After receiving the message from the bill cycle cut off module, the main control module controls the subsequent rating and billing module to carry out the rating and billing operation for the service amount used by the user with reference to the information of the result of the bill cycle cut off so as to complete the billing process for the user.

Thus, the billing for a complete call process is implemented.

In addition, another billing approach can be used. As shown in FIG. 4, the main control module periodically sends to the bill cycle cut off module information for detecting bill cycle, and the bill cycle cut off module polls each account. If an account that meets the bill cycle cut off criterion exists, it carries out the bill cycle cut off operation, the reserving and reverse-calculating operation, and the rating and billing operation so as to complete billing. The bill cycle cut off criterion may include: reaching or exceeding the termination time of the bill cycle. Of course, the reserving and reverse-calculating operation may not exist. In such process, the bill cycle cut off operation is triggered in a real-time batch processing mode of the prior art, and therefore is described in short here.

This disclosure further provides a billing system, which includes a billing information collecting and preprocessing module, a main control module, a rating and billing module, and a bill cycle cut off module:

the billing information collecting and preprocessing module is adapted to receive an online billing message and carry out preprocessing for the message, wherein the online billing message includes user identification information and billing information;

the main control module is adapted to transmit a preprocessed online billing message, receive feedback information, and invoke a rating and billing module to carry out billing upon determining that the feedback information includes a result of a bill cycle cut off, receive a result of a rating and billing operation, and return a response for the billing message to an initiator of the online billing message via the billing information collecting and preprocessing module; and

the bill cycle cut off module is adapted to execute an online bill cycle cut off operation after determining that the bill cycle cut off operation is required to be triggered for an account related to the user identification information, and return the result of the bill cycle cut off to the main control module; and

the rating and billing module is adapted to carry out the rating and billing operation according to the billing information.

The aforementioned online billing message may include a session-based message or an event-based message. If the online billing message includes a session-based message, the online billing system may further include: a reserving and reverse-calculating module adapted to accept invocation of the main control module, carry out a reserving and reverse-calculating operation according to the billing information, and return the reserving and reverse-calculating operation to the main control module.

The aforementioned bill cycle cut off module is further adapted to directly return to the main control module information for indicating that no bill cycle cut off is required after determining that no bill cycle cut off operation is required to be triggered for the account related to the user identification information.

The aforementioned main control module is further adapted to periodically send information for detecting a bill cycle; the bill cycle cut off module is further adapted to poll each account, and execute the bill cycle cut off operation if an account that meets a bill cycle cut off criterion exists; and the bill cycle cut off criterion includes reaching or exceeding the termination time of the bill cycle.

This disclosure further provides a bill cycle cut off module, which includes:

a cut off determining unit 510, adapted to receive from a main control module an online billing message including user identification information, and notify a bill cycle cut off unit 520 after determining that a bill cycle cut off operation is required to be triggered for the account related to the user identification information;

the bill cycle cut off unit 520, adapted to execute an online bill cycle cut off operation according to the received notification, obtain a result of the bill cycle cut off, and transmit the result to a result return unit 530; and

the result return unit 530, adapted to transmit to the main control module the result of the bill cycle cut off.

The aforementioned cut off determining unit 510 is further adapted to notify the result return unit 530 after determining that no bill cycle cut off operation is required to be triggered for the account related to the user identification information.

The aforementioned result return unit 530 is further adapted to transmit to the main control module information for indicating that no bill cycle cut off is required.

The aforementioned cut off determining unit 510 is further adapted to receive information for periodically detecting a bill cycle, poll each account, and notify the bill cycle cut off unit 520 to execute the bill cycle cut off operation if an account that meets a bill cycle cut off criterion exists. The bill cycle cut off criterion may include: reaching or exceeding the termination time of the bill cycle.

The embodiments of this disclosure can implement a real-time online bill cycle cut off and avoid loss resulted from out-of-time bill cycle cut off. The embodiments of this disclosure can incorporate online billing and offline billing, can be implemented flexibly, and can easily realize individualized bill cycle setting. During the account cancellation process for the user, this disclosure can shorten the waiting time of the user and improve customer satisfaction.

This disclosure is disclosed by, but not limited to, the above preferred embodiments. Any variation, equivalent and modification within the spirit and principle of this disclosure shall be included within the scope of this disclosure as defined by the appended claims.

What is claimed is:

1. A billing method, comprising:
receiving an online billing message and carrying out preprocessing for the message, wherein the online billing message includes user identification information and billing information; and
executing an online bill cycle cut off operation after determining that the bill cycle cut off operation is required to be triggered for an account related to the user identification information, obtaining a result of the bill cycle cut off, and carrying out a rating and billing operation according to the billing information so as to complete billing.

2. The method according to claim 1, further comprising:
detecting bill cycle information periodically, polling each account, and if an account that meets a bill cycle cut off criterion exists, executing the bill cycle cut off operation and carrying out the rating and billing operation so as to complete billing,
wherein the bill cycle cut off criterion includes reaching or exceeding termination time of a bill cycle.

3. The method according to claim 1, wherein the online billing message comprises a session-based message and an event-based message; and the session-based message includes a billing initiation message, a billing update message and a billing termination message.

4. The method according to claim 2, wherein the online billing message comprises a session-based message and an event-based message; and the session-based message includes a billing initiation message, a billing update message and a billing termination message.

5. The method according to claim 3, further comprising carrying out a reserving and reverse-calculating operation after executing the bill cycle cut off operation if the online billing message comprises a session-based message.

6. The method according to claim 4, further comprising carrying out a reserving and reverse-calculating operation after executing the bill cycle cut off operation if the online billing message comprises a session-based message.

7. The method according to claim 1, wherein a process for the determining that the bill cycle cut off operation is required to be triggered for the account related to the user identification information comprises:
searching for account information related to the user identification information to obtain an account list; and
determining, for each account in the account list in sequence, whether a bill cycle cut off is required according to a preset rule if the number of accounts in the account list is not zero; and carrying out the bill cycle cut off if required,
wherein the preset rule comprises: occurrence time of the billing message is later than termination time of a current bill cycle of a current account.

8. The method according to claim 2, wherein a process for the determining that the bill cycle cut off operation is required to be triggered for the account related to the user identification information comprises:
searching for account information related to the user identification information to obtain an account list; and
determining, for each account in the account list in sequence, whether a bill cycle cut off is required according to a preset rule if the number of accounts in the account list is not zero; and carrying out the bill cycle cut off if required,
wherein the preset rule comprises: occurrence time of the billing message is later than termination time of a current bill cycle of a current account.

9. The method according to claim 1, wherein a process for the executing the online bill cycle cut off operation comprises:
storing charge data of a current bill cycle into a storage position where charge data of a previous bill cycle is stored, clearing the charge data of the current bill cycle except a balance of the current bill cycle, and then changing start and termination time of the current bill cycle to those time having passed through the bill cycle cut off for the account.

10. The method according to claim 2, wherein a process for the executing the online bill cycle cut off operation comprises:
storing charge data of a current bill cycle into a storage position where charge data of a previous bill cycle is stored, clearing the charge data of the current bill cycle except a balance of the current bill cycle, and then changing start and termination time of the current bill cycle to those time having passed through the bill cycle cut off for the account.

11. The method according to claim 1, wherein if two storage spaces for storing charge data of a current bill cycle and charge data of a previous bill cycle respectively exist, and an identifier or a pointer of the current bill cycle and an identifier or a pointer of the previous bill cycle for identifying or pointing to the charge data of the two bill cycles respectively exist, a process for the executing the online bill cycle cut off operation comprises:
exchanging the identifiers or the pointers with each other, clearing the charge data of a bill cycle identified by the exchanged identifier of the current bill cycle or pointed to by the exchanged pointer of the current bill cycle except a balance of the bill cycle, and changing start and termination time of the current bill cycle to those time having passed through the bill cycle cut off for the account.

12. The method according to claim 2, wherein if two storage spaces for storing charge data of a current bill cycle and charge data of a previous bill cycle respectively exist, and an identifier or a pointer of the current bill cycle and an identifier or a pointer of the previous bill cycle for identifying or pointing to the charge data of the two bill cycles respectively exist, a process for the executing the online bill cycle cut off operation comprises:
exchanging the identifiers or the pointers with each other, clearing the charge data of a bill cycle identified by the exchanged identifier of the current bill cycle or pointed to by the exchanged pointer of the current bill cycle except a balance of the bill cycle, and changing start and termination time of the current bill cycle to those time having passed through the bill cycle cut off for the account.

13. The method according to claim 1, wherein:
the online billing message is sent by a network element;
the network element comprises a Service Control Point, a Gateway GPRS Support Node, and a Mobile Switch Center; and
a protocol for bearing the online billing message comprises: Diameter, Radius, or a specific file or stream transfer protocol; the specific file or stream transfer protocol includes File Transfer Protocol, File Transfer Access and Management protocol, IP Detail Record/Stream Processor protocol.

14. A billing system, comprising:
a billing information collecting and preprocessing module, configured to receive an online billing message and carry out preprocessing for the message, wherein the online billing message includes user identification information and billing information;
a main control module, configured to transmit a preprocessed online billing message, receive feedback information, and invoke a rating and billing module to carry out billing upon determining that the feedback information includes a result of a bill cycle cut off, receive a result of a rating and billing operation, and return a response for the billing message to an initiator of the online billing message via the billing information collecting and preprocessing module;
a bill cycle cut off module, configured to execute an online bill cycle cut off operation after determining that the bill cycle cut off operation is required to be triggered for an account related to the user identification information, and return the result of the bill cycle cut off to the main control module; and
a rating and billing module, configured to carry out the rating and billing operation according to the billing information.

15. The system according to claim 14, wherein the online billing message comprises a session-based message and an event-based message; and
if the online billing message comprises a session-based message, the system further comprises: a reserving and reverse-calculating module, configured to accept invocation of the main control module, carry out a reserving and reverse-calculating operation according to the billing information, and return a result of the reserving and reverse-calculating operation to the main control module.

16. The system according to claim 14, wherein the bill cycle cut off module is further configured to directly return to the main control module information for indicating that no bill cycle cut off is required after determining that no bill cycle cut off operation is required to be triggered for the account related to the user identification information.

17. The system according to claim 14, wherein:
the main control module is further configured to periodically send information for detecting a bill cycle;
the bill cycle cut off module is further configured to poll each account, and execute the bill cycle cut off operation if an account that meets a bill cycle cut off criterion exists; and
the bill cycle cut off criterion includes reaching or exceeding termination time of a bill cycle.

18. A bill cycle cut off module, comprising:
a cut off determining unit, configured to receive from a main control module an online billing message including user identification information, and determine whether a bill cycle cut off operation is required to be triggered for an account related to the user identification information;
a bill cycle cut off unit, configured to execute an online bill cycle cut off operation according to a notification from the cut off determining unit and obtain a result of the bill cycle cut off; and
a result return unit, configured to transmit to the main control module the result of the bill cycle cut off received from the bill cycle cut off unit.

19. The bill cycle cut off module according to claim 18, wherein:
the cut off determining unit is further configured to notify the result return unit after determining that no bill cycle cut off operation is required to be triggered for the account related to the user identification information; and
the result return unit is further configured to transmit to the main control module information for indicating that no bill cycle cut off is required.

20. The bill cycle cut off module according to claim 18, wherein:
the cut off determining unit is further configured to receive information for periodically detecting a bill cycle, poll each account, and notify the bill cycle cut off unit to execute the bill cycle cut off operation if an account that meets a bill cycle cut off criterion exists; and
the bill cycle cut off criterion includes reaching or exceeding termination time of a bill cycle.
